(19) United States
(12) Patent Application Publication
(10) Pub. No.: US 2024/0381507 A1
(43) Pub. Date: Nov. 14, 2024

(54) LOAD CONTROL DEVICE HAVING A WIDE OUTPUT RANGE

(71) Applicant: Lutron Technology Company LLC, Coopersburg, PA (US)

(72) Inventors: Stuart W. DeJonge, Riegelsville, PA (US); Steven J. Kober, Center Valley, PA (US); Mark S. Taipale, Harleysville, PA (US)

(73) Assignee: Lutron Technology Company LLC, Coopersburg, PA (US)

(21) Appl. No.: 18/784,017

(22) Filed: Jul. 25, 2024

Related U.S. Application Data
(63) Continuation of application No. 18/333,014, filed on Jun. 12, 2023, now Pat. No. 12,075,538.
Application No. 18/333,014 is a continuation of application No. 17/833,258, filed on Jun. 6, 2022, now Pat. No. 11,716,802.
Application No. 17/833,258 is a continuation of application No. 17/083,236, filed on Oct. 28, 2020, now Pat. No. 11,357,082.
Application No. 17/083,236 is a continuation of application No. 16/683,723, filed on Nov. 14, 2019, now Pat. No. 10,827,575.
Application No. 16/683,723 is a continuation of application No. 16/278,293, filed on Feb. 18, 2019, now Pat. No. 10,517,154.
Application No. 16/278,293 is a continuation of application No. 15/903,989, filed on Feb. 23, 2018, now Pat. No. 10,251,231.
(60) Provisional application No. 62/580,707, filed on Nov. 2, 2017.
(60) Provisional application No. 62/562,066, filed on Sep. 22, 2017.

(51) Int. Cl. H05B 45/44; H05B 45/10; H05B 45/3725; H05B 45/50; H05B 47/155

(52) U.S. Cl. CPC H05B 45/44; H05B 45/10; H05B 45/3725; H05B 45/50; H05B 47/155

(57) ABSTRACT

A load control device (e.g., an LED driver) for controlling the intensity of a lighting load (e.g., an LED light source) may provide a wide output range and flicker-free adjustment of the intensity of the lighting load. The load control device may comprise a load regulation circuit, a control circuit, and a filter circuit (e.g., a boxcar filter circuit) that operates in a different manner in dependence upon a target current. When the intensity of the lighting load is near a low-end intensity, the control circuit may adjust an operating frequency of the load regulation circuit in response to the target current, and may control the filter circuit to filter a current feedback signal during a filter window that repeats on periodic basis. When the intensity of the lighting load is near a high-end intensity, the control circuit may control the filter circuit to constantly filter the current feedback signal.

### CROSS-REFERENCE TO RELATED APPLICATIONS

This application is a continuation of U.S. application Ser. No. 18/333,014, filed Jun. 12, 2023; which is a continuation of U.S. application Ser. No. 17/833,258 filed Jun. 6, 2022, now U.S. Pat. No. 11,716,802 issued Aug. 1, 2023; which is a continuation of U.S. application Ser. No. 17/083,236, filed Oct. 28, 2020, now U.S. Pat. No. 11,357,082, issued Jun. 7, 2022; which is a continuation of U.S. application Ser. No. 16/683,723, filed Nov. 14, 2019, now U.S. Pat. No. 10,827,575, issued Nov. 3, 2020; which is a continuation of U.S. application Ser. No. 16/278,293, filed on Feb. 18, 2019, now U.S. Pat. No. 10,517,154, issued Dec. 24, 2019; which is a continuation of U.S. application Ser. No. 15/903,989, filed on Feb. 23, 2018, now U.S. Pat. No. 10,251,231, issued Apr. 2, 2019; which claims the benefit of U.S. Provisional Patent Application No. 62/580,707, filed Nov. 2, 2017, and U.S. Provisional Patent Application No. 62/562,066, filed Sep. 22, 2017, the disclosures of which are hereby incorporated by reference in their entireties.

### BACKGROUND

Light-emitting diode (LED) light sources (e.g., LED light engines) are replacing conventional incandescent, fluorescent, and halogen lamps as a primary form of lighting devices. LED light sources may comprise a plurality of light-emitting diodes mounted on a single structure and provided in a suitable housing. LED light sources may be more efficient and provide longer operational lives as compared to incandescent, fluorescent, and halogen lamps. An LED driver control device (e.g., an LED driver) may be coupled between a power source, such as an alternating-current (AC) power source or a direct-current (DC) power source, and an LED light source for regulating the power supplied to the LED light source. For example, the LED driver may regulate the voltage provided to the LED light source, the current supplied to the LED light source, or both the current and voltage.

Different control techniques may be employed to drive LED light sources including, for example, a current load control technique and a voltage load control technique. An LED light source driven by the current load control technique may be characterized by a rated current (e.g., approximately 350 milliamps) to which the magnitude (e.g., peak or average magnitude) of the current through the LED light source may be regulated to ensure that the LED light source is illuminated to the appropriate intensity and/or color. An LED light source driven by the voltage load control technique may be characterized by a rated voltage (e.g., approximately 15 volts) to which the voltage across the LED light source may be regulated to ensure proper operation of the LED light source. If an LED light source rated for the voltage load control technique includes multiple parallel strings of LEDs, a current balance regulation element may be used to ensure that the parallel strings have the same impedance so that the same current is drawn in each of the parallel strings.

The light output of an LED light source may be dimmed. Methods for dimming an LED light source may include, for example, a pulse-width modulation (PWM) technique and a constant current reduction (CCR) technique. In pulse-width modulation dimming, a pulsed signal with a varying duty cycle may be supplied to the LED light source. For example, if the LED light source is being controlled using a current load control technique, the peak current supplied to the LED light source may be kept constant during an on-time of the duty cycle of the pulsed signal. The duty cycle of the pulsed signal may be varied, however, to vary the average current supplied to the LED light source, thereby changing the intensity of the light output of the LED light source. As another example, if the LED light source is being controlled using a voltage load control technique, the voltage supplied to the LED light source may be kept constant during the on-time of the duty cycle of the pulsed signal. The duty cycle of the load voltage may be varied, however, to adjust the intensity of the light output. Constant current reduction dimming may be used if an LED light source is being controlled using the current load control technique. In constant current reduction dimming, current may be continuously provided to the LED light source. The DC magnitude of the current provided to the LED light source, however, may be varied to adjust the intensity of the light output.

Examples of LED drivers are described in U.S. Pat. No. 8,492,987, issued Jul. 23, 2013, entitled LOAD CONTROL DEVICE FOR A LIGHT-EMITTING DIODE LIGHT SOURCE; U.S. Pat. No. 9,655,177, issued May 16, 2017, entitled FORWARD CONVERTER HAVING A PRIMARY-SIDE CURRENT SENSE CIRCUIT; and U.S. Pat. No. 9,247,608, issued Jan. 26, 2016, entitled LOAD CONTROL DEVICE FOR A LIGHT-EMITTING DIODE LIGHT SOURCE; the entire disclosures of which are hereby incorporated by reference.

### SUMMARY OF THE INVENTION

As described herein, a load control device (e.g., an LED driver) for controlling the intensity of a lighting load (e.g., an LED light source) may provide a wide output range for current conducted through the lighting load to achieve flicker-free adjustment of the intensity of the lighting load. Since the load control device is characterized by a wide output range, the load control device may be able to control a large variety of different lighting loads having different ratings (e.g., different rated output currents and/or rated output voltages). This may allow a manufacturer of the load control device, a manufacturer of a fixture of the light source (such as an original equipment manufacturer (OEM)), and/or a distributer of the load control device and/or the fixture to maintain stock of a smaller number of stock keeping units (SKUs).

The load control device may comprise a load regulation circuit, a control circuit, and a filter circuit (e.g., such as a boxcar filter circuit) that operates in a different manner in dependence upon the intensity (e.g., a target intensity) of the load control device in order to provide the wide output range. The load regulation circuit may control the magnitude of a load current conducted through the lighting load to adjust the intensity of the lighting load between a low-end intensity and a high-end intensity. The filter circuit may receive a current feedback signal from the load regulation circuit and filter the current feedback signal to generate a filtered feedback signal. The control circuit may be operatively coupled to the load regulation circuit for controlling the magnitude of the load current towards a target current in response to the filtered feedback signal. When the intensity of the lighting load is near the low-end intensity (e.g., when the magnitude of the target current is less than a transition current), the control circuit may adjust an operating frequency of the load regulation circuit in response to the target current, and may control the filter circuit to filter the current feedback signal during a filter window that repeats on a periodic basis. When the intensity of the lighting load is near the high-end intensity (e.g., when the magnitude of the target current is greater than the transition current), the control circuit may control the filter circuit to constantly filter the current feedback signal. The control circuit may generate a filter control signal for controlling the filter circuit to filter the current feedback signal during the filter window when the magnitude of the target current is less than the transition current, and control the filter control signal to have a maximum duty cycle (e.g., 100%) when the magnitude of the target current is greater than the transition current.

### BRIEF DESCRIPTION OF THE DRAWINGS

FIG. 1 is a simplified block diagram of an example light-emitting diode (LED) driver for controlling the intensity of an LED light source.

FIG. 2 is a simplified schematic diagram of an example LED driver.

FIG. 3A is an example plot of a relationship between an operating frequency and a target current of the LED driver of FIG. 2.

FIG. 3B is an example plot of a relationship between a magnitude of a target-current control signal and the target current of the LED driver of FIG. 2.

FIGS. 4A and 4B show example waveforms illustrating the operation of the LED driver of FIG. 2.

FIG. 5A shows example waveforms illustrating the operation of the LED driver of FIG. 2 when the LED driver is learning a load voltage.

FIG. 5B shows example waveforms illustrating the operation of the LED driver of FIG. 2 when the LED driver is turning on an LED light source using the learned load voltage.

FIG. 6 is a simplified flowchart of an example control procedure for controlling an LED driver to control a magnitude of a load current conducted through a lighting load.

### DETAILED DESCRIPTION

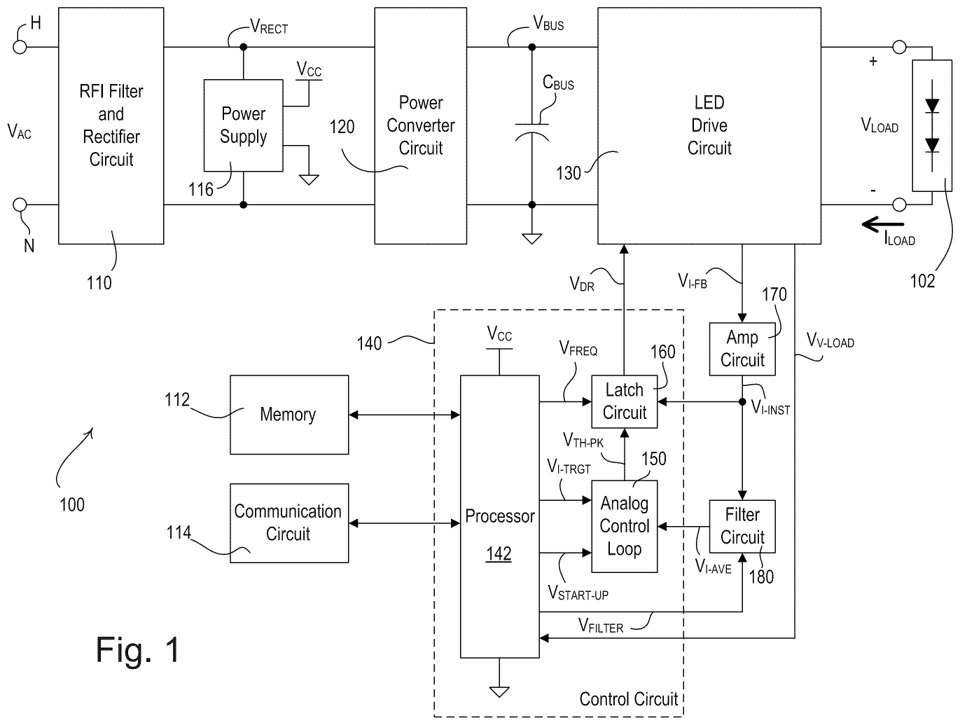

FIG. 1 is a simplified block diagram of a load control device, such as a light-emitting diode (LED) driver 100 for controlling the intensity of an LED light source 102 (e.g., an LED light engine). The LED light source 102 is shown in FIG. 1 as a plurality of LEDs connected in series but may comprise a single LED or a plurality of LEDs connected in parallel or a suitable combination thereof, depending on the particular lighting system. In addition, the LED light source 102 may alternatively comprise one or more organic light-emitting diodes (OLEDs). The LED driver 100 may be adapted to work with a plurality of different LED light sources, which may be rated at different magnitudes of load current and voltage.

The LED driver 100 may comprise a hot terminal H and a neutral terminal N for receiving an alternating-current (AC) voltage V_{AC} from an AC power source (not shown). The LED driver 100 may comprise a radio-frequency (RFI) filter and rectifier circuit 110, which may receive the AC voltage V_{AC}. The RFI filter and rectifier circuit 110 may operate to minimize the noise provided on the AC power source and to generate a rectified voltage VRECT. The LED driver 100 may comprise a power converter circuit 120, which may receive the rectified voltage VRECT and generate a variable direct-current (DC) bus voltage V_{Bus} across a bus capacitor C_{BUs}. The power converter circuit 120 may comprise any suitable power converter circuit for generating an appropriate bus voltage, such as, for example, a boost converter, a buck converter, a buck-boost converter, a flyback converter, a single-ended primary-inductance converter (SEPIC), a Ćuk converter, or other suitable power converter circuit. The power converter circuit 120 may also provide electrical isolation between the AC power source and the LED light source 102, and operate as a power factor correction (PFC) circuit to adjust the power factor of the LED driver 100 towards a power factor of one.

The LED driver 100 may comprise a load regulation circuit, e.g., an LED drive circuit 130, which may receive the bus voltage V_{Bus} and control the amount of power delivered to the LED light source 102 so as to control the intensity of the LED light source. For example, the LED drive circuit 130 may comprise a buck converter, as will be described in greater detail below. To control the amount of power delivered to the LED light source 102, the LED drive circuit 130 may be configured to control an average magnitude of a load current I_{LOAD} conducted through the LED light source 102.

The LED driver 100 may include a control circuit 140 for controlling the operation of the power converter circuit 120 and the LED drive circuit 130. The control circuit 140 may comprise, for example, a controller or any other suitable processing device, such as, for example, a microcontroller, a programmable logic device (PLD), a microprocessor, an application specific integrated circuit (ASIC), or a field-programmable gate array (FPGA). The control circuit 140 may be configured to control the LED drive circuit 130 to control the average magnitude of the load current I_{LOAD} conducted through the LED light source to control the amount of power delivered to the LED light source. The control circuit 140 may be configured to control the LED drive circuit 130 to turn the LED light source 102 on and off and to adjust (e.g., dim) a present intensity L_{PRES} of the LED light source 102 towards a target intensity L_{TRGT}, which may range across a dimming range of the LED light source, e.g., between a low-end intensity L_{LE} (e.g., approximately 0.1%-1.0%) and a high-end intensity L_{HE} (e.g., approximately 100%).

The control circuit may be configured to fade (e.g., gradually adjust over a period of time) the target intensity L_{TRGT} (and thus the present intensity L_{PRES}) of the LED light source 102. The control circuit 140 may be configured to fade the LED light source 102 from off to on by slowly increasing the present intensity L_{PRES} of the LED light source from a minimum fading intensity L_{FADE-MIN}, which may be less than the low-end intensity L_{LE} (e.g., such as approximately 0.02%), to the target intensity L_{TRGT}. The control circuit 140 may be configured to fade the LED light source 102 from on to off by slowly decreasing the present intensity L_{PRES} of the LED light source from an initial intensity greater than or equal to the low-end intensity L_{LE} to the minimum fading intensity L_{FADE-MIN} at which point the control circuit 140 may turn off the LED light source.

The control circuit 140 may be coupled to a memory 112 configured to store operational characteristics of the LED driver 100 (e.g., the target intensity L_{TRGT}, the low-end intensity L_{LE}, the high-end intensity L_{HE}, etc.). The memory 112 may be implemented as an external integrated circuit (IC) or as an internal circuit of the control circuit 140. The LED driver 100 may also comprise a communication circuit 114, which may be coupled to, for example, a wired communication link or a wireless communication link, such as a radio-frequency (RF) communication link or an infrared (IR) communication link. The control circuit 140 may be configured to determine the target intensity L_{TRGT} of the LED light source 102 or the operational characteristics stored in the memory 112 in response to digital messages received via the communication circuit 114. In response to receiving a command to turn on the LED light source 102, the control circuit 140 may be configured to execute the turn-on routine. The LED driver 100 may further comprise a power supply 116, which may receive the rectified voltage VRECT and generate a direct-current (DC) supply voltage V_{cc} (e.g., approximately 5 volts) for powering the low-voltage circuitry of the LED driver. In addition, the power supply 116 may generate one or more additional supply voltages, for example, for powering control circuitry of the power converter circuit 120 and/or the LED drive circuit 130.

The control circuit 140 may comprise a digital control circuit, such as a processor 142, which may be, for example, a microprocessor, a programmable logic device (PLD), a microcontroller, an application specific integrated circuit (ASIC), a field-programmable gate array (FPGA), or other suitable processing device or controller. The control circuit 140 may also comprise an analog control loop circuit 150. The processor 142 and the analog control loop circuit 150 may operate together to control the LED driver circuit 130 to adjust the average magnitude of the load current I_{LOAD} towards a target current I_{TRGT}. The target current I_{TRGT} may be dependent upon the target intensity L_{TRGT} (e.g., a function of the target intensity L_{TRGT}). The processor 142 may generate a target-current control signal V_{I-TRGT}, which may have a DC magnitude or a duty cycle that may indicate the target current I_{TRGT}. The processor 142 may control the DC magnitude or the duty cycle of the target-current control signal V_{I-TRGT} based on the target intensity L_{TRGT} of the LED light source 102.

The control circuit 140 may also comprise a latch circuit 160 that may generate a drive signal V_{DR} for controlling the operation of the LED drive circuit 130 (e.g., for rendering a switching transistor of the LED drive circuit 130 conductive and non-conductive to regulate the average magnitude of the load current I_{LOAD} towards the target current I_{TRGT}). The processor 142 may generate a frequency control signal V_{FREQ} that may set an operating frequency fop of the LED drive circuit 130. In response to the frequency control signal V_{FREQ}, the latch circuit 160 may control the drive signal V_{DR} to render the switching transistor of the LED drive circuit 130 conductive to start a cycle of the LED drive circuit, at which time the LED drive circuit may begin to conduct an inductor current I_{L}, conducted through an inductor (not shown) of the LED drive circuit 130. The analog control loop circuit 150 may generate a peak current threshold V_{TH-PK}, which may be used by the latch circuit 160 to render the switching transistor of the LED drive circuit 130 non-conductive in response to the magnitude of the inductor current I_{L}.

The LED driver 100 may comprise an amplifier circuit 170, which may receive a current feedback signal V_{I-FB} from the LED drive circuit 130. The amplifier circuit 170 may amplify the current feedback signal V_{I-FB} to generate an instantaneous current feedback signal V_{I-INST}, which may indicate an instantaneous magnitude of the inductor current I_{L}, flowing through the inductor of the LED drive circuit 130.

The LED driver 100 may further comprise a filter circuit 180, such as a boxcar filter circuit. The filter circuit 180 may receive the instantaneous current feedback signal V_{I-INST} and generate a filtered feedback signal, e.g., an average current feedback signal V_{I-AVE}, which may indicate an average magnitude of the inductor current I_{L} flowing through the inductor of the LED drive circuit 130 (e.g., over a specific time window). The processor 142 may generate a filter control signal V_{FILTER} (e.g., a filter control signal) for controlling the operation of the filter circuit 180, e.g., to control when the filter circuit 180 filters the instantaneous current feedback signal V_{I-INST}. For example, the processor 142 may control the filter control signal V_{FILTER} to allow the filter circuit 180 to filter the instantaneous current feedback signal V_{I-INST} over a filter window period T_{FILTER} during each cycle of the LED drive circuit 130. The processor 142 may control the filter control signal V_{FILTER} in a manner that is synchronous with the frequency control signal V_{FREQ}, e.g., to start a cycle of the LED drive circuit 130 at the beginning of the filter window period T_{FILTER}. For example, the filter window period T_{FILTER} may have the same length during each cycle of the LED drive circuit 130 independent of the frequency of the frequency control signal V_{FREQ}. The magnitude of the average current feedback signal V_{I-AVE} may indicate the average magnitude of the inductor current I_{L}, during the filter window period T_{FILTER} (e.g., while the filter circuit 180 is filtering the instantaneous current feedback signal V_{I-INST}).

The analog control loop circuit 150 of the control circuit 140 may receive the average current feedback signal V_{I-AVE} and the latch circuit 160 may receive the instantaneous current feedback signal V_{I-INST}. The analog control loop circuit 150 may adjust the magnitude of the peak current threshold V_{TH-PK} in response to the target-current control signal V_{I-TRGT} and the average current feedback signal V_{I-AVE}. The latch circuit 160 may control the drive signal V_{DR} to render the switching transistor of the LED drive circuit 130 conductive in response to the frequency control signal V_{FREQ} (e.g., at the beginning of a cycle of the LED drive circuit 130). The latch circuit 160 may control the drive signal V_{DR} to render the switching transistor non-conductive in response to the peak current threshold V_{TH-PK} and the instantaneous current feedback signal V_{I-INST}. After rendering the switching transistor of the LED drive circuit 130 non-conductive, the latch circuit 160 may remain in a latched state and maintain the switching transistor non-conductive until the beginning of the next cycle of the LED drive circuit 130.

The control circuit 140 may be configured to determine or learn (e.g., measure or receive an indication of) one or more operational characteristics of the LED light source 102 (e.g., learned load characteristics). For example, the control circuit 140 may be configured to determine a voltage representative of the magnitude of the load voltage V_{LOAD}. The magnitude of the load voltage V_{LOAD} generated across the LED light source 102 may be dependent upon the magnitude of the load current I_{LOAD} (e.g., the target load current I_{TRGT} to which the control circuit 140 is regulating the load current I_{LOAD}) as well as the internal circuitry of the LED light source. The control circuit 140 may be configured to determine (e.g., measure) the magnitude of the load voltage V_{LOAD} and/or store the measurement in the memory 112 as a learned load voltage V_{LEARNED}. The control circuit 140 may be configured to determine (e.g., measure) the magnitude of the load voltage V_{LOAD} using a load voltage feedback signal V_{V-LOAD} received from the LED drive circuit 130. For example, the LED drive circuit 130 may comprise a resistive divider circuit (not shown) coupled across the LED light source 102 for generating the load voltage feedback signal V_{v-LOAD} as a scaled load voltage. The load voltage feedback signal V_{V-LOAD} may be received by an analog-to-digital converter (ADC) of the processor 142 for learning the magnitude of the load voltage V_{LOAD}.

The control circuit 140 may be configured to determine (e.g., measure) the magnitude of the load voltage V_{LOAD} when the target intensity L_{TRGT} is at or near the low-end intensity L_{LE}. For example, the control circuit 140 may be configured to determine (e.g., measure) the magnitude of the load voltage V_{LOAD} while the control circuit 140 is fading the LED light source 102 from on to off, for example, while the average magnitude of the load current I_{LOAD} is within a measurement window that may range from a maximum learning threshold I_{LEARN-MAX} to a minimum learning threshold I_{LEARN-MIN}. The maximum learning threshold I_{LEARN-MAX} and the minimum learning threshold I_{LEARN-MIN} may be functions of a rated (or maximum) current I_{RATED} of the LED light source 102, for example, 0.0020. I_{RATED} and 0.0002. I_{RATED}, respectively.

The control circuit 140 may be configured to control the LED drive circuit 130 using the learned load voltage V_{LEARNED}. For example, the control circuit 140 may be configured to control the LED drive circuit 130 in response to the learned load voltage V_{LEARNED} when turning on the LED light source 102. The control circuit 140 may be configured to charge (e.g., “pre-charge”) an output capacitor (not shown) of the LED drive circuit 130 prior to attempting to turn on the LED light source 102. In response to receiving a command to turn on the LED light source 102 and/or in response to power being applied to the LED driver 100 to turn on the LED light source, the control circuit 140 may pre-charge the output capacitor until the magnitude of the load voltage V_{LOAD} reaches or exceeds a pre-charge voltage threshold V_{TH-PC}, which may be, for example, a function of the learned load voltage V_{LEARNED} (e.g., as will be described in greater detail below). The pre-charging of the output capacitor may allow the LED driver 100 to turn-on the LED light source 102 quickly and consistently, e.g., when fading on to the low-end intensity L_{LE}.

The control circuit 140 may be configured to determine an operating parameter (e.g., a pre-load parameter) as a function of the learned load voltage V_{LEARNED} and use the operating parameter to control the LED drive circuit 130 to pre-charge the output capacitor of the LED drive circuit 130 prior to turning the LED light source 102 on (e.g., as will be described in greater detail below). For example, the control circuit 140 may be configured to determine the DC magnitude or the duty cycle of the target-current control signal V_{I-TRGT} to use while pre-charging the output capacitor of the LED drive circuit 130 as a function of the learned load voltage V_{LEARNED}. In addition, the processor 142 may generate a start-up control signal V_{START-UP} for controlling the analog control loop circuit 150 while pre-charging the output capacitor of the LED drive circuit 130 to maintain the output of the analog control loop circuit 150 at a predetermined voltage.

After the magnitude of the load voltage V_{LOAD} reaches or exceeds the pre-charge voltage threshold V_{TH-PC}, the processor 142 may control the start-up control signal V_{START-UP} to allow the analog control loop circuit 150 to control the LED drive circuit 130 using closed loop control in response to the current feedback signal V_{I-FB} to regulate the magnitude of the load current I_{LOAD} towards the target current I_{TRGT}.

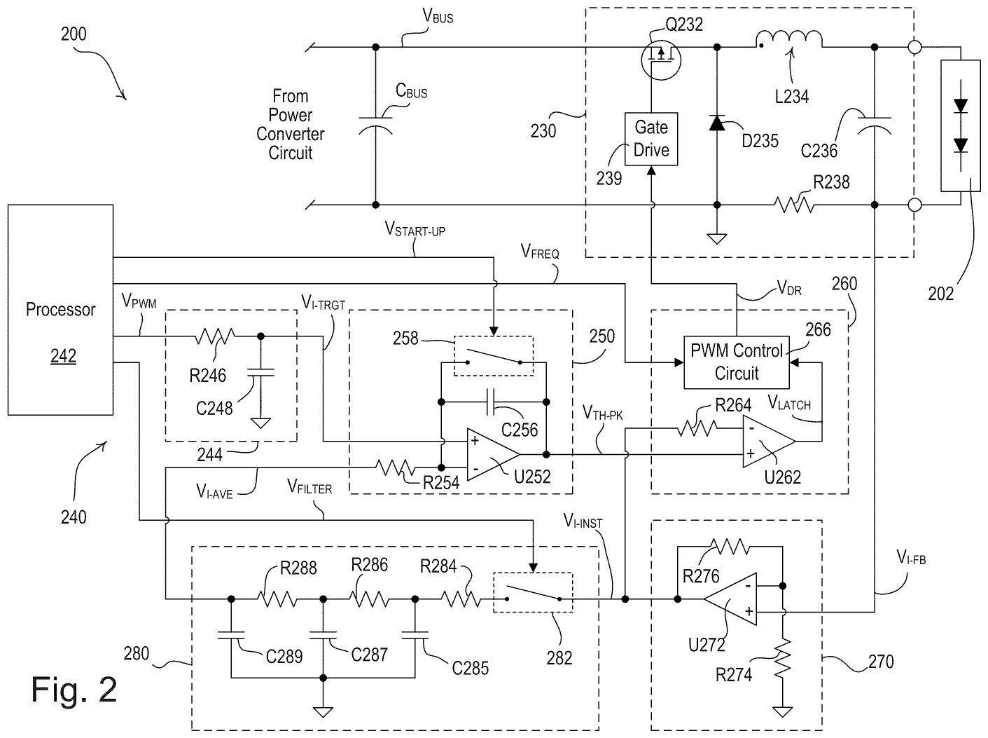

FIG. 2 is a simplified schematic diagram of a load regulation device, e.g., an LED driver 200 (such as the LED driver 100 of FIG. 1) for controlling the intensity of an LED light source 202. The LED driver 200 may comprise a bus capacitor C_{Bus} for storing a bus voltage V_{BUS}, which may be generated by a power converter circuit (e.g., the power converter circuit 120 of the LED driver 100). The LED driver 200 may comprise an LED drive circuit 230, which may be configured to control the magnitude of a load current I_{LOAD} conducted through the LED light source 202. The LED driver 200 may further comprise a control circuit 240, which may be a hybrid analog-digital control circuit (e.g., the control circuit 140 of the LED driver 100). The control circuit 240 may comprise a processor 242, a low-pass filter circuit 244, an analog control loop circuit (e.g., which may include an integrator circuit 250), and a latch circuit 260. The latch circuit 260 may generate a drive signal V_{DR}, which may be provided to the LED driver circuit 230. The LED driver 200 may further comprise an amplifier circuit 270 and a filter circuit 280 (e.g., a boxcar filter circuit) for generating an instantaneous current feedback signal V_{I-INST} and an average current feedback signal V_{I-AVE}, respectively.

As shown in FIG. 2, the LED drive circuit 230 may comprise a buck converter. The LED drive circuit 230 may comprise a switching transistor, e.g., a field-effect transistor (FET) Q232, which may be controlled in response to the drive signal V_{DR} to control the average magnitude of the load current I_{LOAD}. The LED drive circuit 230 may also comprise an inductor L234, a switching diode D235, an output capacitor C236, and a feedback resistor R238. The drive signal V_{DR} may be coupled to a gate of the FET Q232 through a gate drive circuit 239. When the FET Q232 is conductive, the inductor L234 may conduct an inductor current I_{L} from the bus capacitor C_{BUS} through the parallel combination of the output capacitor C236 and the LED light source 202. When the FET Q232 is non-conductive, the inductor L234 may conduct the inductor current I_{L} through the switching diode D235 and the parallel combination of the output capacitor C236, and the LED light source 202. The LED light source 202 may conduct the average component of the inductor current I_{L}, and the output capacitor C236 may conduct the transient component of the inductor current I_{L}. The average magnitude of the load current I_{LOAD} may be approximately equal to the average magnitude of the inductor current I_{L}.

The current feedback signal V_{I-FB} may be generated across the feedback resistor R238 of the LED drive circuit 230 and may be proportional to the magnitude of the inductor current I_{L}. The current feedback signal V_{I-FB} may be received by the amplifier circuit 270. The amplifier circuit 270 may comprise an operational amplifier U272 and may be configured as a non-inverting amplifier circuit. The operational amplifier U272 may have a non-inverting input that may receive the current feedback signal V_{I-FB}. The amplifier circuit 270 may also comprise a resistor R274 coupled between an inverting input of the operational amplifier U272 and circuit common, and a resistor R276 coupled between the inverting input and an output of the operational amplifier U272. The amplifier circuit 270 may be configured to generate the instantaneous current feedback signal V_{I-INST}, which may be an amplified version of the current feedback signal V_{I-FB} and may indicate the instantaneous magnitude of the inductor current I_{L}.

The filter circuit 280 may filter the instantaneous current feedback signal V_{I-INST} to generate the average load current signal V_{I-AVE}, which may indicate the average magnitude of the inductor current I_{L}. The filter circuit 280 may comprise a controllable switching circuit 282 and a low-pass filter circuit (e.g., a third-order low-pass filter circuit) that includes resistors R284, R286, R288 and capacitors C285, C287, C289. The processor 242 may generate a filter control signal V_{FILTER} for rendering the controllable switching circuit 282 conductive and non-conductive. When the controllable switching circuit 282 is conductive, the filter circuit 280 may be configured to filter the instantaneous current feedback signal V_{I-INST} to generate the average current feedback signal V_{I-AVE}. When the controllable switching circuit 282 is non-conductive, the capacitors C285, C287, C289 of the filter circuit 280 may maintain the magnitude of the average current feedback signal V_{I-AVE} at a value that indicates the average magnitude of the inductor current II, during the period of time when the controllable switching circuit 282 was previously conductive.

The processor 242 may generate a pulse-width modulated (PWM) signal V_{PWM}, which may be received by the low-pass filter circuit 244 of the control circuit 240. The low-pass filter circuit 244 may be configured to generate a target-current control signal V_{I-TRGT}, which may have a DC magnitude that indicates the target current I_{TRGT}. For example, the low-pass filter circuit 244 may comprise a resistor-capacitor (RC) circuit having a resistor R246 and a capacitor C248. The processor 242 may be configured to control the duty cycle of the pulse-width modulated signal V_{PWM} to adjust the magnitude of the target-current control signal V_{I-TRGT}.

The average current feedback signal V_{I-AVE} generated by the filter circuit 280 and the target-current control signal V_{I-TRGT} generated by the low-pass filter circuit 244 may be received by the integrator circuit 250. The integrator circuit 250 may comprise an operational amplifier U252 having a non-inverting input coupled to the target-current control signal V_{I-TRGT} and an inverting input coupled to the average current feedback signal V_{I-AVE} via a resistor R254. The integrator circuit 250 may comprise a capacitor C256 coupled between the inverting input and an output of the operational amplifier U252, such that the integrator circuit 250 may be configured to integrate the error between the average current feedback signal V_{I-AVE} and the target-current control signal V_{I-TRGT}. The integrator circuit 250 may generate a peak current threshold V_{TH-PK} having a DC magnitude that may increase or decrease by amounts dependent upon the error between the magnitude of the target-current control signal V_{I-TRGT} and the average current feedback signal V_{I-AVE}. The integrator circuit 250 may comprise a controllable switching circuit 258 coupled in parallel with the capacitor C256. The controllable switching circuit 258 may be rendered conductive and non-conductive in response to a startup control signal V_{START-UP} received from the processor 242 during a startup routine (e.g., as will be described in greater detail below).

The latch circuit 260 may receive the peak current threshold V_{TH-PK} generated by the integrator circuit 250 and the instantaneous current feedback signal V_{I-INST} generated by the amplifier circuit 270. The latch circuit 260 may comprise a comparator U262 configured to compare the magnitude of the instantaneous current feedback signal V_{I-INST} to the magnitude of the peak current threshold V_{TH}. The comparator U262 may generate a latch control signal V_{LATCH} at an output. When the magnitude of the instantaneous current feedback signal V_{I-INST} is less than the magnitude of the peak current threshold V_{TH}, the comparator U262 may drive the latch control signal V_{LATCH} at the output high (e.g., towards the supply voltage V_{cc}). When the magnitude of the instantaneous current feedback signal V_{I-INST} exceeds the magnitude of the peak current threshold V_{TH-PK}, the comparator U262 may drive the latch control signal V_{LATCH} at the output low (e.g., towards circuit common).

The processor 242 may generate a frequency control signal V_{FREQ} that may set an operating frequency for of the LED drive circuit 230. The latch circuit 260 may comprise a PWM control circuit 266, which may receive the latch control signal V_{LATCH} from the comparator U262 and the frequency control signal V_{FREQ} from the processor 242. The PWM control circuit 266 may generate the drive signal V_{DR}, which may be received by the gate drive circuit 239 of the LED drive circuit 230. When the frequency control signal V_{FREQ} is driven high at the beginning of a cycle of the LED driver circuit 230, the PWM control circuit 266 may drive the magnitude of the drive signal V_{DR} high, which may render the FET Q232 of the LED drive circuit 230 conductive. When the magnitude of the instantaneous current feedback signal V_{I-INST} exceeds the magnitude of the peak current threshold signal V_{TH}, the comparator U262 may drive the latch control signal V_{LATCH} low, which may cause the PWM control circuit 266 to drive the magnitude of the drive signal V_{DR} low. The PWM control circuit 266 may maintain the magnitude of the drive signal V_{DR} low until the processor 242 drives the magnitude of the frequency control signal V_{FREQ} high once again at the end of the present cycle and the beginning of the next cycle of the LED drive circuit 230.

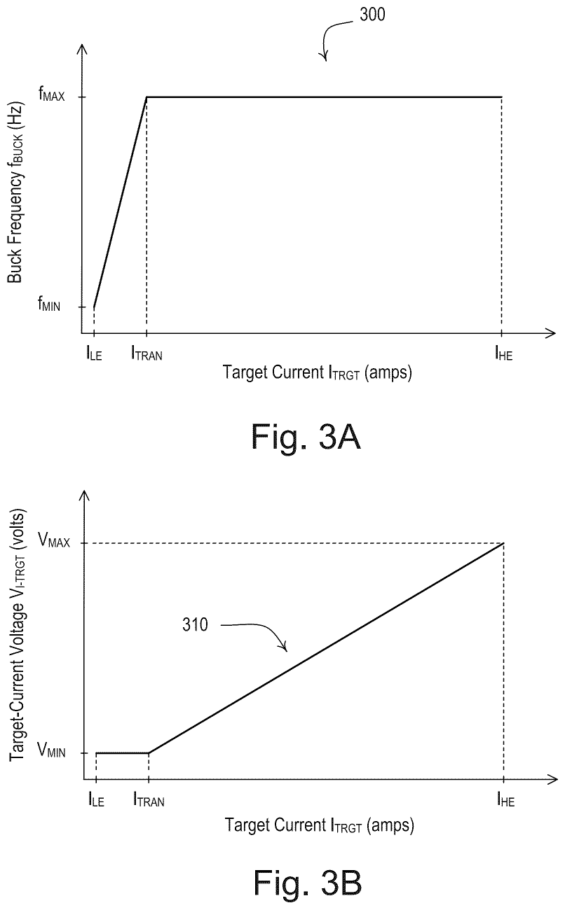

The processor 242 may control the frequency of the frequency control signal V_{FREQ} and the duty cycle of the pulse-width modulated control signal V_{PwM} (and thus the magnitude of the target-current control signal V_{I-TRGT}) in dependence upon the target current I_{TRGT} of the LED light source 202 using open loop control. FIG. 3A is an example plot of the relationship 300 between the frequency of the frequency control signal V_{FREQ} (e.g., the operating frequency for of the LED drive circuit 230) and the target current I_{TRGT}. FIG. 3B is an example plot of the relationship 310 between the magnitude of the target-current control signal V_{I-TRGT} and the target current I_{TRGT}. For example, the target current I_{TRGT} may range between a high-end current I_{HE} (e.g., approximately 150 mA) at the high-end intensity L_{HE} and a low-end current ILE (e.g., approximately 150 μA) at the low-end intensity L_{LE}.

The processor 242 may operate in first and second modes of operation depending upon whether the target current I_{TRGT} is less than or greater than approximately a transition current I_{TRAN} (e.g., approximately 16.8 mA). Near the low-end intensity L_{LE} (e.g., when the target current I_{TRGT} is less than approximately the transition current I_{TRAN}), the processor 242 may operate in the first operating mode during which the processor 242 may adjust the frequency of the frequency control signal V_{FREQ} between a minimum operating frequency f_{MIN} and a maximum operating frequency f_{MAX} (e.g., linearly) with respect to the target current I_{TRGT} while holding the magnitude of the target-current control signal V_{I-TRGT} constant (e.g., at a minimum voltage V_{MIN}). Near the high-end intensity L_{HE} (e.g., when the target current I_{TRGT} is greater than or equal to approximately the transition current I_{TRAN}), the processor 242 may operate in the second operating mode during which the processor 242 may adjust the magnitude of the target-current control signal V_{I-TRGT} between the minimum voltage V_{MIN} and a maximum voltage V_{MAX} (e.g., linearly) with respect to the target current I_{TRGT} while holding the frequency control signal V_{FREQ} constant (e.g., at the maximum operating frequency f_{MAX}). For example, the maximum operating frequency f_{MAX} may be approximately 140 kHz and the minimum operating frequency f_{MIN} may be approximately 1250 Hz. For example, the maximum voltage V_{MAX} may be approximately 3.3 V and the minimum voltage V_{MIN} may be approximately 44 mV.

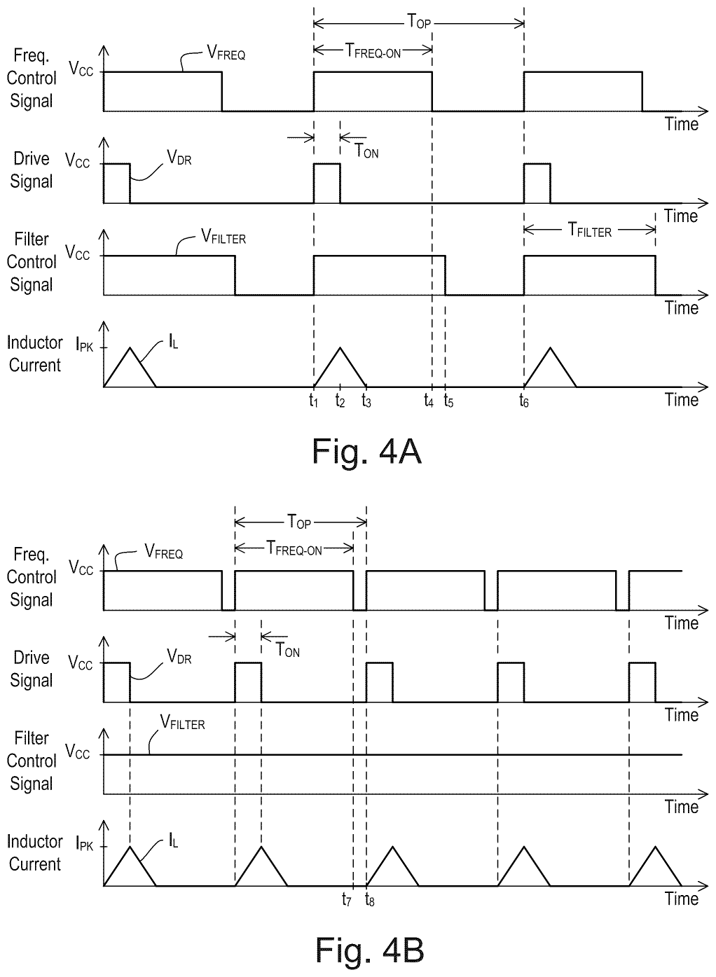

FIGS. 4A and 4B show example waveforms illustrating the operation of the LED driver 200 shown in FIG. 2. FIG. 4A shows example waveforms illustrating the operation of the LED driver 200 when the target current I_{TRGT} is less than the transition current I_{TRAN}. The processor 242 may generate the frequency control signal V_{FREQ} to set the operating frequency for of the LED drive circuit 230. For example, an operating period Tₒₚ of the LED drive circuit 230 may be equal to the period of the frequency control signal V_{FREQ}. The processor 242 may set the operating frequency fop (and thus the operating period T_{OP}) in dependence upon the target current I_{TRGT} (e.g., as shown in FIG. 3A). The processor 242 may generate the frequency control signal V_{FREQ} to have a predetermined on-time T_{FREQ-ON}, which may have the same length each cycle of the LED drive circuit 130 (e.g., independent of the frequency of the frequency control signal V_{FREQ} or the target current I_{TRGT}).

The processor 242 may generate the filter control signal V_{FILTER} in a synchronous manner with respect to the frequency control signal V_{FREQ}. For example, the processor 242 may drive both the filter control signal V_{FILTER} and the frequency control signal V_{FREQ} high at the same time to start a cycle of the LED drive circuit 230 (e.g., at time t₁ in FIG. 4A). At time t₁, the PWM control circuit 266 of the latch circuit 260 may drive the magnitude of the drive signal V_{DR} high (e.g., towards the supply voltage V_{cc}) causing the FET Q232 of the LED drive circuit 230 to be rendered conductive. At this time, the inductor L234 of the LED drive circuit 230 may begin to conduct the inductor current I_{L}. When the instantaneous current feedback signal V_{I-INST} (which may be proportional to the magnitude of the inductor current I_{L}.) exceeds the magnitude of the peak current threshold signal V_{TH}, the PWM control circuit 266 may drive the magnitude of the drive voltage V_{DR} low (e.g., towards circuit common) as shown at time t₂ of FIG. 4A, which may cause the FET Q232 of the LED drive circuit 230 to be rendered non-conductive. The drive signal V_{DR} may be characterized by an on-time Tₒₓ and a period that may be equal to the operating period Tₒₚ as shown in FIG. 4A. The PWM control circuit 266 may render the FET Q232 conductive for the length of the on-time Tₒₓ of the drive signal V_{DR} during each operating cycle of the LED drive circuit 230. The inductor current I_{L} may have a peak magnitude I_{pK} as shown in FIG. 4A. The magnitude of the inductor current I_{L}, may begin to decrease at time t₂ until the magnitude of the inductor current I_{L} drops to zero amps at time t₃.

The processor 242 may drive the frequency control signal V_{FREQ} low at the end of the predetermined on-time T_{FREQ-ON} (e.g., at time t₄ in FIG. 4A). The processor 242 may drive the filter control signal V_{FILTER} low at the end of a filter window period T_{FILTER} (e.g., at time t₅ in FIG. 4A). The processor 242 may drive both the filter control signal V_{FILTER} and the frequency control signal V_{FREQ} high to start another cycle of the LED drive circuit 230 at the end of the operating period Tₒₚ (e.g., at time to in FIG. 4A).

When the target current I_{TRGT} is less than the transition current I_{TRAN}, the processor 242 may hold the magnitude of the target-current control signal V_{I-TRGT} constant at the minimum voltage V_{MIN}, and linearly adjust the frequency of the frequency control signal V_{FREQ} between the minimum frequency fix and the maximum frequency f_{MAX} as a function of the target current I_{TRGT} (e.g., as shown in FIGS. 3A and 3B). The filter circuit 280 may be configured to filter the instantaneous current feedback signal V_{I-INST} during the filter window period T_{FILTER} each cycle of the LED drive circuit 230. When the target current I_{TRGT} is less than the transition current I_{TRAN}, the filter control signal V_{FILTER} may be a periodic signal characterized by the operating frequency for. The processor 242 may maintain the length of the filter window period T_{FILTER} of the filter control signal V_{FILTER} constant from one cycle of the LED driver circuit 230 to the next cycle independent of the frequency of the frequency control signal V_{FREQ}. A duty cycle of the filter control signal V_{FILTER} may vary as the frequency of the frequency control signal V_{FREQ} is adjusted.

Since the target-current control signal V_{I-TRGT} and the filter window period T_{FILTER} are held constant, the on-time Tₒₓ of the drive signal V_{DR} may be approximately the same each cycle of the LED drive circuit 230 even though the frequency of the drive signal V_{DR} (e.g., the operating period Tₒₚ) may vary in dependence upon the target current I_{TRGT}. As a result, the peak and average magnitudes of the inductor current I_{L}, during the filter window period T_{FILTER} may be approximately the same from one cycle to the next of the LED drive circuit 230 independent of the target current I_{TRGT} when the target current I_{TRGT} is less than the transition current I_{TRAN}. The length of the filter window period T_{FILTER} may be sized to ensure that the inductor current I_{L} drops to zero amps before the end of the filter window period T_{FILTER} when the target current I_{TRGT} is less than the transition current I_{TRAN}. When the target current is less than the transition current I_{TRAN}, the LED drive circuit 230 may be configured to operate in a discontinuous mode of operation.

FIG. 4B shows example waveforms illustrating the operation of the LED driver 200 when the target current I_{TRGT} is greater than the transition current I_{TRAN}. When the target current I_{TRGT} is greater than the transition current I_{TRAN}, the processor 242 may linearly adjust the magnitude of the target-current control signal V_{I-TRGT} between the minimum voltage V_{MIN} and the maximum voltage V_{MAX} as a function of the target current I_{TRGT} (e.g., as shown in FIGS. 3A and 3B). In addition, the processor 242 may hold the frequency of the frequency control signal V_{FREQ} constant at the maximum operating frequency f_{MAX} (e.g., causing the operating period Tₒₚ to be held constant at a minimum operating period T_{MIN}). When the target current I_{TRGT} is greater than the transition current I_{TRAN}, the processor 242 may control the duty cycle of the filter control signal V_{FILTER} to a maximum filter duty cycle (e.g., 100%). For example, the operating period Tₒₚ may be equal to the length of the filter window period T_{FILTER} when the target current I_{TRGT} is greater than the transition current I_{TRAN}. As a result, the processor 242 may drive the filter control signal V_{FILTER} high at all times (e.g., the filter control signal V_{FILTER} is a constant signal) while the target current I_{TRGT} IS greater than the transition current I_{TRAN} as shown in FIG. 4B. The average current feedback signal V_{I-AVE} may indicate the average magnitude of the inductor current I_{L} when the target current I_{TRGT} is greater than the transition current I_{TRAN}. Additionally or alternatively, the processor 242 may drive the filter control signal V_{FILTER} high approximately all of the time (e.g., almost all of the time), for example at substantially large duty cycle (e.g., approximately 90% or greater).

Because the processor 242 varies the magnitude of the target-current control signal V_{I-TRGT} as a function of the target current I_{TRGT}, the length of the on-time Tₒₓ of the drive signal V_{DR} may vary as a function of the target current I_{TRGT} even though the frequency of the drive signal V_{DR} (e.g., the operating period T_{OP}) is held constant. As the target current I_{TRGT} increases, the peak current I_{PK} of the inductor current may increase to a point at which the LED drive circuit 230 may begin to operate in a continuous mode of operation. Since the minimum operating period T_{MIN} (e.g., the operating period Tₒₚ when the target current I_{TRGT} is greater than the transition current I_{TRAN}) may be equal to the length of the filter window time period T_{FILTER}, the processor 242 may be configured to smoothly transition the LED driver 200 between the first operating mode when the target current I_{TRGT} is less than the transition current I_{TRAN} and the second operating mode when the target current I_{TRGT} is greater than the transition current I_{TRAN}.

The length of the predetermined on-time T_{FREQ-ON} of the frequency control signal T_{FREQ} is less than the length of the operating period Tₒₚ when the target current I_{TRGT} is greater than the transition current I_{TRAN}. The processor 242 may drive the frequency control signal T_{FREQ} low (e.g., at time t₇ in FIG. 4B) and then high (e.g., at time t₈) at the end of each cycle of the LED drive circuit 230. This causes the PWM control circuit 266 of the latch circuit 260 to stop maintaining the magnitude of the drive signal V_{DR} low, and to drive the magnitude of the drive signal V_{DR} high again when the frequency control signal T_{FREQ} is driven high to begin the next cycle of the LED drive circuit 230 (e.g., at time to).

The processor 242 of the control circuit 240 may be configured to determine or learn (e.g., measure or receive an indication of) the magnitude of the load voltage V_{LOAD} and/or store the measurement in memory (e.g., the memory 112) as a learned load voltage V_{LEARNED}. The magnitude of the load voltage V_{LOAD} generated across the LED light source 202 may be dependent upon the magnitude of the load current I_{LOAD} (e.g., the target load current I_{TRGT} to which the control circuit 240 is regulating the load current I_{LOAD}) as well as the internal circuitry of the LED light source. The processor 242 may be configured to receive a load voltage feedback signal from the LED drive circuit 230 (e.g., the load voltage feedback signal V_{V-LOAD} of the LED driver 100), which may be a scaled version of the load voltage V_{LOAD} generated by a resistive divider circuit (not shown) of the LED drive circuit 230. The processor 242 may sample the load voltage feedback signal using an analog-to-digital converter (ADC) to measure the magnitude of the load voltage V_{LOAD}.

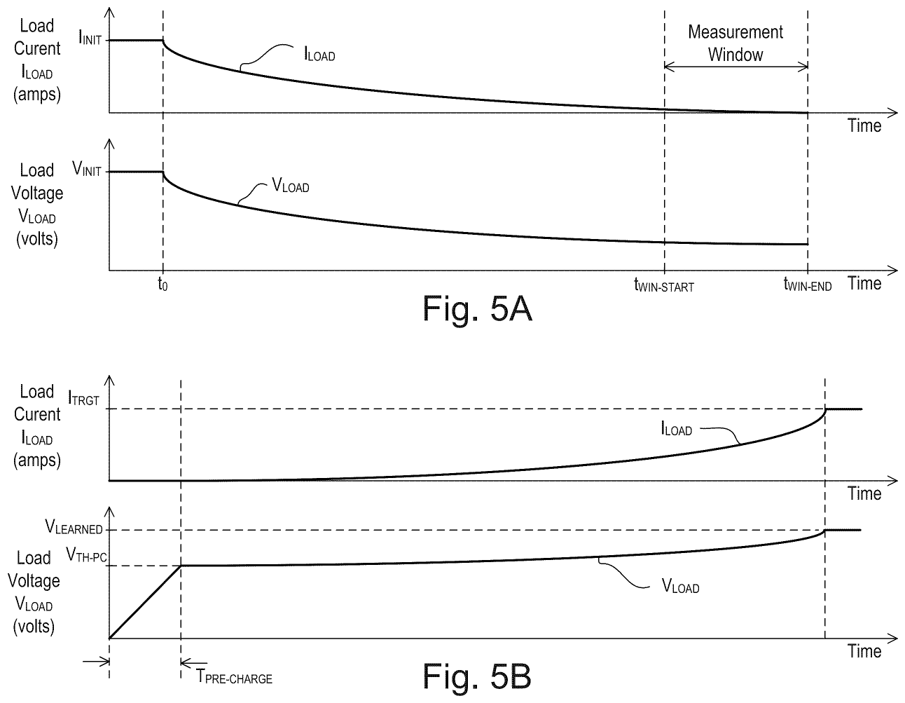

FIG. 5A shows example waveforms illustrating the operation of the LED driver 200 when the processor 242 is learning the load voltage V_{LOAD}. The processor 242 may be configured to determine (e.g., measure) the magnitude of the load voltage V_{LOAD} while the processor 242 is fading the LED light source 202 from on to off. As shown in FIG. 5A, when fading the LED light source 202 from on to off, the processor 242 may begin to decrease the average magnitude of the load current I_{LOAD} from an initial current I_{INIr} at time t₀, at which time the magnitude of the load voltage V_{LOAD} may also begin to decrease, e.g., from an initial voltage VINIT. The processor 242 may be configured to determine (e.g., measure) the magnitude of the load voltage V_{LOAD} while the average magnitude of the load current I_{LOAD} is within a measurement window that may range from a maximum learning threshold I_{LEARN-MAX} and a minimum learning threshold I_{LEARN-MIN} (e.g., between times t_{WIN-START} and t_{WIN-END} as shown in FIG. 5A). The maximum learning threshold I_{LEARN-MAX} and the minimum learning threshold I_{LEARN-MIN} may be functions of a rated (or maximum) current I_{RATED} of the LED light source 202, for example, 0.0020. I_{RATED} and 0.0002. I_{RATED}, respectively. The processor 242 may be configured to periodically sample the load voltage feedback signal during the measurement window, and to process the plurality of samples to determine the learned load voltage V_{LEARNED}. For example, the processor 242 may be configured to process the plurality of samples of the load voltage feedback signal by calculating an average or median value of the plurality of samples or filtering the samples using a digital low-pass filter.

The processor 242 may be configured to measure the load voltage V_{LOAD} and determine the learned load voltage V_{LEARNED} when (e.g., each time that) the processor 242 turns the LED light source 202 off (e.g., fades the LED light source off). The processor 242 may be configured to overwrite the learned load voltage V_{LEARNED} stored in the memory with the learned load voltage V_{LEARNED} determined the last time that the processor 242 turned off the LED light source 202. In addition, the processor 242 may be configured to process the learned load voltages V_{LEARNED} from multiple turn-off events (e.g., calculate the average or median value of the multiple learned load voltages) before overwriting the learned load voltage V_{LEARNED} stored in the memory.

The processor 242 may be configured to control the LED drive circuit 230 using the learned load voltage V_{LEARNED}, for example, when turning on the LED light source 202. FIG. 5B shows example waveforms illustrating the operation of the LED driver 200 when the processor 242 is fading on the LED light source 202 (e.g., fading on to a target intensity L_{TRGT} that corresponds to a target current I_{TRGT}). In response to receiving a command to turn on the LED light source 202 and/or in response to power being applied to the LED driver 200 to turn on the LED light source, the processor 242 may be configured to pre-charge the output capacitor C236 of the LED drive circuit 230 during a pre-charge period T_{PRE-CHARGE} prior to attempting to turn on the LED light source 202. During the pre-charge period T_{PRE-CHARGE}, the processor 242 may be configured to control the duty cycle of the pulse-width modulated signal V_{PWM} (and thus the DC magnitude of the target-current control signal V_{I-TRGT}) as a function of the learned load voltage V_{LEARNED} to cause the output capacitor C236 to charge faster than normal (e.g., faster than if the processor 242 controlled the DC magnitude of the target-current control signal V_{I-TRGT} in response to the target current I_{TRGT} as shown in FIG. 3B). The faster rate at which the output capacitor C236 charges during the pre-charge period T_{PRE-CHARGE} may allow the processor 242 to turn-on the LED light source 202 quickly and consistently, e.g., when fading the LED light source on to the low-end intensity L_{LE}.

The control circuit 240 may be configured to pre-charge the output capacitor C236 of the LED drive circuit 230 until the magnitude of the load voltage V_{LOAD} reaches or exceeds a pre-charge voltage threshold V_{TH-PC}. The pre-charge voltage threshold V_{TH-PC} may be determined, for example, as a function of the learned load voltage V_{LEARNED} (e.g., V_{TH-PC}=a. V_{LEARNED}, where a is a constant that may be, for example, approximately 0.90). Since the magnitude of the load voltage V_{LOAD} may be greater when the LED light source 202 is cold than when the LED light source 202 is warm, the constant α may be sized to be less than one to ensure that the LED drive circuit 230 does not overshoot the learned load voltage V_{LEARNED} when pre-charging the output capacitor C236. Additionally or alternatively, the pre-charge voltage threshold V_{TH-PC} may be determined, for example, using a different function of the learned load voltage V_{LEARNED} (e.g., V_{TH-PC}=V_{LEARNED}-β, where β is a constant that may be, for example, approximately one volt). Additionally or alternatively, the pre-charge voltage threshold V_{TH-PC} may be a fixed threshold (e.g., a predetermined threshold). The processor 242 may be configured to cease pre-charging the output capacitor C236 if the magnitude of the load voltage V_{LOAD} does not exceed the pre-charge voltage threshold V_{TH-PC} within a timeout period. The processor 242 may be configured to select the value of the duty cycle of the pulse-width modulated signal V_{PwM} based on the learned load voltage V_{LEARNED} such that pre-charge period T_{PRE-CHARGE} for the LED driver 200 may be approximately the same for different LED light sources that have different resulting load voltages.

The processor 242 may control the start-up control signal V_{START-UP} to render the controllable switching circuit 258 of the integrator circuit 250 conductive during the pre-charge period T_{PRE-CHARGE}. After the magnitude of the load voltage V_{LOAD} reaches or exceeds the pre-charge voltage threshold V_{TH-PC}, the processor 242 may control the start-up control signal V_{START-UP} to render the controllable switching circuit 258 of the integrator circuit 250 non-conductive. This may allow the integrator circuit 250 and the latch circuit 260 to control the LED drive circuit 230 using closed loop control in response to the current feedback signal V_{I-FB} to regulate the magnitude of the load current I_{LOAD} towards the target current I_{TRGT}.

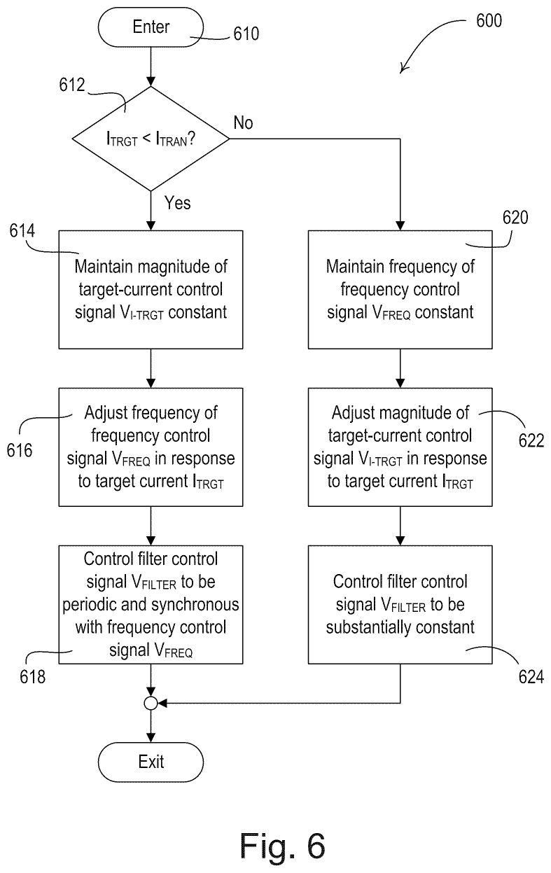

FIG. 6 is a simplified flowchart of an example control procedure 600 for controlling a load control device (e.g., the LED driver 200) to control a magnitude of a load current conducted through a lighting load (e.g., the LED light source 202). The control procedure 600 may be executed by a control circuit of the load control device (e.g., the control circuit 240 of the LED driver 200) at step 610, for example, periodically and/or in response to a change in the target current I_{TRGT} for the lighting load. If the target current I_{TRGT} is less than the transition current I_{TRAN} at 612 (e.g., when the target intensity L_{TRGT} in near the low-end intensity L_{LE}), the control circuit may maintain the magnitude of the target-current control signal V_{I-TRGT} constant (e.g., at the minimum voltage V_{MIN}) at 614, and may adjust the frequency of the frequency control signal V_{FREQ} in response to the target current I_{TRGT} (e.g., as shown in FIG. 3A) at 616. The control circuit may then control a filter circuit (e.g., the filter circuit 280) at 618 by controlling the filter control signal V_{FILTER} to be periodic (e.g., having the same frequency of the frequency control signal V_{FREQ}) and synchronized to the frequency control signal V_{FREQ} (e.g., as shown in FIG. 4A). The control procedure 600 may then exit.

If the target current I_{TRGT} is greater than the transition current I_{TRAN} (e.g., greater than or equal to the transition current I_{TRAN}) at 612 (e.g., when the target intensity L_{TRGT} in near the high-end intensity L_{HE}), the control circuit may maintain the frequency of the frequency control signal V_{FREQ} constant (e.g., at the maximum operating frequency f_{MAX}) at 620, and may adjust the magnitude of the target-current control signal V_{I-TRGT} in response to the target current I_{TRGT} (e.g., as shown in FIG. 3B) at 622. The control circuit may then control the filter control signal V_{FILTER} to be substantially constant at 624, before the control procedure 600 exits. For example, the control circuit may drive the control signal V_{FILTER} using a maximum duty cycle, such as 100% (e.g., by constantly driving the filter control signal V_{FILTER} high as shown in FIG. 4B), or a substantially high duty cycle (e.g., 90% or greater) at 624.

1. A light-emitting diode controller, comprising:
a filter circuit to receive an instantaneous current feedback signal from an operatively coupled light-emitting diode (LED) drive circuit; and
an LED control circuit operatively coupled to the filter circuit and to the LED drive circuit, the LED control circuit to:
receive an input that includes a target intensity;
determine a target load current to provide the target intensity;
determine whether the target intensity is less than a defined threshold intensity;
responsive to a determination by the LED control circuit that the target intensity is below the defined threshold intensity:
generate a first current control signal to cause the LED drive circuit to output a load current at a minimum target current;
generate a first frequency control signal to cause the LED drive circuit to adjust an output operating frequency between a minimum operating frequency and a maximum operating frequency based on the received target intensity;
cause the filter circuit to sample an instantaneous current feedback signal received from the LED drive circuit synchronous with the output operating frequency to determine an average load current; and
adjust the first frequency control signal based on the determined average load current and the determined target load current.

2. The LED controller of claim 1, further comprising:
a latch circuit operatively coupled to the LED control circuit;
wherein to generate the first frequency control signal, the LED control circuit to:
communicate the first frequency control signal to the latch circuit;
wherein, responsive to receipt of the first frequency control signal, the latch circuit to generate a first output signal to cause the LED drive circuit to output an operating frequency between the minimum operating frequency and the maximum operating frequency.

3. The LED controller of claim 1 wherein the LED control circuit to further:
responsive to the determination by the LED control circuit that the target intensity is at or above the defined threshold intensity:
generate a second frequency control signal to cause the LED drive circuit to output an operating frequency at the maximum operating frequency;
generate a second current control signal to cause the LED drive circuit to adjust the load current between the minimum target current and a maximum target current based on the received target intensity; and
cause the filter circuit to continuously sample the instantaneous current feedback signal received from the LED drive circuit to determine the average load current; and
adjust the second current control signal based on the determined average load current and the determined target load current.

4. The LED controller of claim 3, further comprising:
a latch circuit operatively coupled to the LED control circuit and to the LED drive circuit;
wherein to generate the second frequency control signal, the LED control circuit to further:
communicate a maximum operating frequency control signal to the latch circuit;
wherein the latch circuit to generate a second output signal to cause the LED drive circuit to operate at the maximum operating frequency responsive to receipt of the maximum operating frequency control signal.

5. The LED controller of claim 4, further comprising:
an analog control loop circuit operatively coupled to the LED control circuit and to the LED drive circuit;
wherein to generate the second current control signal, the LED control circuit to further:
communicate the second current control signal to the analog control loop circuit;
wherein, responsive to receipt of the second current control signal, the analog control loop circuit to generate a third output signal to cause the LED drive circuit to output a load current between the minimum target current and the maximum target current.

6. The LED controller of claim 1, further comprising:
a memory circuit communicatively coupled to the LED control circuit;
wherein to determine the target load current to provide the target intensity, the LED control circuit to further:
retrieve from the memory circuit data representative of a relationship between intensity of an operatively coupled LED emitter and a load current supplied to the operatively coupled LED emitter.

7. The LED controller of claim 6 wherein to determine whether the target intensity is less than the defined threshold intensity, the LED control circuit to further:
retrieve from the memory circuit data representative of a threshold load current that corresponds to the threshold intensity; and
determine whether the determined target load current is less than the threshold load current.

8. A light-emitting diode (LED) control method, comprising:
receiving, by an LED control circuit, an input that includes a target intensity;
determining, by the LED control circuit, a target load current to provide the target intensity;
determining, by the LED control circuit, whether the target intensity is less than a defined threshold intensity;
responsive to a determination by the LED control circuit that the target intensity is below the defined threshold intensity:
generating, by the LED control circuit, a first current control signal to cause an LED drive circuit operatively coupled to the LED control circuit to output a load current at a minimum target current;
generating, by the LED control circuit, a first frequency control signal to cause the LED drive circuit to adjust an output operating frequency between a minimum operating frequency and a maximum operating frequency based on the received target intensity;
causing, by the LED control circuit, a filter circuit operatively coupled to the LED control circuit to sample an instantaneous current feedback signal received from the LED drive circuit synchronous with the output operating frequency to determine an average load current; and
adjusting, by the LED control circuit, the first frequency control signal based on the determined average load current and the determined target load current.

9. The LED control method of claim 8 wherein generating the first frequency control signal further comprises:
communicating, by the LED control circuit, the first frequency control signal to a latch circuit operatively coupled to the LED control circuit and to the LED drive circuit; and
generating, by the latch circuit, a first output signal to cause the LED drive circuit to output an operating frequency between the minimum operating frequency and the maximum operating frequency responsive to receipt of the first frequency control signal.

10. The LED control method of claim 8, further comprising:
responsive to the determination by the LED control circuit that the target intensity is at or above the defined threshold intensity:
generating, by the LED control circuit, a second frequency control signal to cause the LED drive circuit to output an operating frequency at the maximum operating frequency;
generating, by the LED control circuit, a second current control signal to cause the LED drive circuit to adjust the load current between the minimum target current and a maximum target current based on the received target intensity; and
causing, by the LED control circuit, the filter circuit to continuously sample the instantaneous current feedback signal received from the LED drive circuit to determine the average load current; and
adjusting, by the LED control circuit, the second current control signal based on the determined average load current and the determined target load current.

11. The LED control method of claim 10 wherein generating the second frequency control signal, further comprises:
communicating, by the LED control circuit, the second frequency control signal to a latch circuit operatively coupled to the LED control circuit and to the LED drive circuit; and
generating, by the latch circuit, a second output signal to cause the LED drive circuit to operate at the maximum operating frequency responsive to receipt of the second frequency control signal.

12. The LED control method of claim 11 wherein generating the second current control signal, further comprises:
communicating, by the LED control circuit, the second current control signal to an analog control loop circuit operatively coupled to the LED control circuit; and
generating, by the analog control loop circuit, a third output signal to cause the LED drive circuit to output a load current between the minimum target current and the maximum target current responsive to receipt of the second current control signal.

13. The LED control method of claim 8 wherein determining the target load current to provide the target intensity further comprises:
retrieving, by the LED control circuit from a memory circuit operatively coupled to the LED control circuit, data representative of a relationship between intensity of an operatively coupled LED emitter and a load current supplied to the operatively coupled LED emitter.

14. The LED control method of claim 13 wherein determining whether the target intensity is less than the defined threshold intensity further comprises:
retrieving, by the LED control circuit, from the memory circuit data representative of a threshold load current that corresponds to the threshold intensity; and
determining, by the LED control circuit, whether the determined target load current is less than the threshold load current.

15. A non-transitory, machine-readable, storage device that includes instructions that when executed by a light-emitting diode (LED) control circuit, cause the LED control circuit to:
receive an input that includes a target intensity;
determine a target load current to provide the target intensity;
determine whether the target intensity is less than a defined threshold intensity;
responsive to a determination by the LED control circuit that the target intensity is below the defined threshold intensity:
generate a first current control signal to cause an LED drive circuit operatively coupled to the LED control circuit to output a load current at a minimum target current;
generate a first frequency control signal to cause the LED drive circuit to adjust an output operating frequency between a minimum operating frequency and a maximum operating frequency based on the received target intensity;
cause a filter circuit operatively coupled to the LED control circuit to sample an instantaneous current feedback signal received from the LED drive circuit synchronous with the output operating frequency to determine an average load current; and
adjust the first frequency control signal based on the determined average load current and the determined target load current.

16. The non-transitory, machine-readable, storage device of claim 15 wherein the instructions that cause the LED control circuit to generate the first frequency control signal, further cause the LED control circuit to:
communicate the first frequency control signal to a latch circuit operatively coupled to the LED control circuit and to the LED drive circuit;
wherein, responsive to receipt of the first frequency control signal, the latch circuit to generate a first output signal to cause the LED drive circuit to output an operating frequency between the minimum operating frequency and the maximum operating frequency.

17. The non-transitory, machine-readable, storage device of claim 15 wherein the instructions, when executed by the LED control circuit, further cause the LED control circuit to:
responsive to the determination that the target intensity is at or above the defined threshold intensity:
generate a second frequency control signal to cause the LED drive circuit to output an operating frequency at the maximum operating frequency;
generate a second current control signal to cause the LED drive circuit to adjust the load current between the minimum target current and a maximum target current based on the received target intensity; and
cause the filter circuit to continuously sample the instantaneous current feedback signal received from the LED drive circuit to determine the average load current; and
adjust the second current control signal based on the determined average load current and the determined target load current.

18. The non-transitory, machine-readable, storage device of claim 17 wherein the instructions that cause the LED control circuit to generate the second frequency control signal, further cause the LED control circuit to:
communicate the second frequency control signal to a latch circuit operatively coupled to the LED control circuit and to the LED drive circuit;
wherein, responsive to receipt of the second frequency control signal from the LED control circuit, the latch circuit to generate a second output signal to cause the LED drive circuit to operate at the maximum operating frequency.

19. The non-transitory, machine-readable, storage device of claim 18 wherein the instructions that cause the LED control circuit to generate the second current control signal further cause the LED control circuit to:
communicate the second current control signal to an analog control loop circuit operatively coupled to the LED control circuit and to the LED drive circuit;
wherein, responsive to receipt of the second current control signal, the analog control loop circuit to generate a third output signal to cause the LED drive circuit to output a load current between the minimum target current and the maximum target current.

20. The non-transitory, machine-readable, storage device of claim 15 wherein the instructions that cause the LED control circuit to determine the target load current to provide the target intensity further cause the LED control circuit to:
retrieve, from memory circuit operatively coupled to the LED control circuit, data representative of a relationship between intensity of an operatively coupled LED emitter and a load current supplied to the operatively coupled LED emitter.

21. The non-transitory, machine-readable, storage device of claim 20 wherein the instructions that cause the LED control circuit to determine whether the target intensity is less than the defined threshold intensity, further cause the LED control circuit to:
retrieve, from the memory circuit, data representative of a threshold load current that corresponds to the threshold intensity; and
determine whether the determined target load current is less than the threshold load current.
